(19) United States
(12) Patent Application Publication
(10) Pub. No.: US 2006/0272928 A1
(43) Pub. Date: Dec. 7, 2006

(54) Device for conveying and separating ferromagnetic parts

(76) Inventor: Johann Kritzinger, Frankenburg (AT)

Correspondence Address: WILLIAM COLLARD;COLLARD & ROE, P.C., 1077 NORTHERN BOULEVARD, ROSLYN, NY, 11576, US

(21) Appl. No.: 11/432,635

(22) Filed: May 11, 2006

(30) Foreign Application Priority Data
May 11, 2005 (AT) A 803/2005

(51) Int. Cl. B65G 15/58

(52) U.S. Cl. 198/690.1

(57) ABSTRACT

The invention relates to a device (11) for conveying and separating ferromagnetic parts (2), in particular long parts, in a conveying direction extending transversely to the longitudinal axis of the parts (2), comprising at least two magnet arrangements (66) disposed on a frame (88), spaced apart from one another transversely to the conveying direction and forming a conveyor run (67) extending between them in the conveying direction from an infeed portion (70) to a feed position (4), with poles (68) of a different type facing one another which create a magnetic field penetrating the parts (2) to be conveyed in order to separate the parts (2) by mutual repulsion. A conveying mechanism (73) is disposed in the region of the conveyor run (67) incorporating separating elements (75) disposed at a distance apart from one another in the conveying direction which can be moved along the conveyor run (67) in the active range of the magnetic field by means of a drive (74), which sub-divide the conveyor run (67) into several consecutive receiving regions (76) which respectively guide at least one part (2) if necessary.

### CROSS REFERENCE TO RELATED APPLICATIONS

Applicant claims priority under 35 U.S.C. §119 of AUSTRIAN Patent Application No. A 803/2005 filed on May 11, 2005.

### BACKGROUND OF THE INVENTION

1. Field of the Invention

The invention relates to a device for conveying and separating ferromagnetic parts, in particular long parts, in a conveying direction extending transversely to the longitudinal axis of the parts, comprising at least two magnet arrangements disposed on a frame, spaced apart from one another transversely to the conveying direction and forming a conveyor run extending between them in the conveying direction from an infeed portion to a feed position, with poles of a different type facing one another which create a magnetic field penetrating the parts to be conveyed in order to separate the parts by mutual repulsion.

2. The Prior Art

Patent specification DE 40 38 841 A1 discloses a device for conveying and separating magnetisable parts, whereby two oppositely lying side walls and a base part bound a transport path for the parts, and a magnetic field generated by magnet arrangements connected to the side walls acts on the parts, placing them in a hovering state. The magnet arrangement comprises permanent magnets for generating the magnetic field and electromagnets which can be energised one after the other in cycles in order to partially demagnetise the workpieces in the feed direction. These local weaknesses of the magnetic field cause magnetic force components in the feed direction, which cause a forward movement of the workpieces and the longitudinal axis of the parts is oriented horizontally and transversely to the direction of movement. Another feature of this device is that the frame side walls supporting the magnet arrangements can be moved on the base part relative to one another in order to change the frame width, thereby enabling parts of different lengths to be conveyed and separated. The disadvantage of this design is the highly complex circuitry needed to control activation of the electro-magnets in order to convey the parts. Furthermore, large distances occur between the parts on more or less horizontal conveyor runs and very short distances occur between the parts on conveyor runs with a steep upward or downward incline. This results in large fluctuations in the throughput rate.

### SUMMARY OF THE INVENTION

The objective of the invention is to propose a device for conveying and separating ferromagnetic parts which is simple in terms of its construction but is reliable in operation and permits an increased throughput rate.

This objective is achieved by the invention on the basis of the features specified in the characterising part of claim 1. The advantage of this approach is that the separating elements moved along the conveyor run enable the hovering parts to be reliably controlled. The mutual repulsion forces acting between the parts are able to move the individual parts only as far as the next separating element, irrespective of the number of parts there are in the device. As a result of the separating elements, the distance between two consecutive parts can be limited to a pre-set maximum and a more or less constant throughput rate is achieved irrespective of the inclination of the conveyor run. Another advantage achieved as a result of the conveyor device is that the parts are forcibly guided along at least certain portions of the conveyor run, which means that vertically descending or vertically rising or even overhanging conveyor sections can be set up if a strong enough magnetic field is provided. In addition, the throughput rate of the device can be further increased because the speed at which the separating elements and hence the parts contained in the receiving regions are moved along the conveyor run can be increased by increasing the drive speed of the conveyor device.

The embodiment defined in claim 2 is also of advantage because in regions in which the parts are not guided by the separating elements, the movements of the parts along the conveyor run caused by the mutual repulsion forces are not prevented and the parts are distributed and therefore separated uniformly in the available space due to the mutual repulsion in the magnetic field.

The embodiment of the conveyor device specified in claim 3 in the form of an endlessly circulating traction drive is particularly efficient in straight conveyor portions due to a simple construction and the versatility of different possible options with regard to the nature and shape of separating elements. These may be plate-shaped, of a bolt type or pin type, for example.

The almost vertical disposition of the separating elements on an external peripheral surface of the traction means specified in claim 4 enables the separating elements to be braked in steeply descending conveyor portions and in steeply rising conveyor portions the parts can be pushed forwards.

The design of the device specified in claim 5 is suitable for conveyor tasks in situations where it is not possible to construct a straight conveyor run due to spatial conditions. In such situations, it is also possible for the conveyor run to have a lateral inclination as viewed in the feed direction because a side face of the parts is guided along the lowermost boundary surface in this case.

Also of advantage is the design of the magnet arrangements for generating the magnetic field with electro-magnets defined in claim 6, whereby the intensity of the magnetic field can be regulated simply by adjusting the supply voltage. This enables parts of different lengths and hence different weights to be moved always along the same conveyor surface by adjusting the magnetic field. Heavier parts would otherwise “hang” lower in the magnetic field than lighter parts. Due to the fact that the oppositely lying electromagnets are disposed with their mid-axes in alignment with one another, the magnetic field lines run at a right angle to the transport direction and hence also the longitudinal axes of the parts. This results in a largely homogeneous magnetic field, thereby largely preventing uncontrolled movements of the parts in the magnetic field.

The adjustability of the distance between the magnet arrangements as defined in claim 7 is also used to adapt to different part lengths and ensures that shorter as well as longer parts are provided with sufficient lateral guidance as viewed in the transport direction. The adjustment process is advantageously effected on an automated basis by means of a control unit.

The embodiment of the device defined in claim 8 with a frame of ferromagnetic material intensifies the magnetic field between the two oppositely lying magnet arrangements. If there are no permanent magnets in the magnet arrangements and only electromagnets are used to generate the magnetic field, the power consumption of the electro-magnets can be reduced as a result. This also minimises magnetic stray fields outside of the device because, apart from in the region of the conveyor run between the two oppositely lying magnet arrangements, the magnetic field lines mainly run inside the ferromagnetic frame.

In another advantageous embodiment defined in claim 9, the device has an adjustable frame part which can be lifted off a stationary frame, thereby enabling the distance between the oppositely lying magnet arrangements to be adjusted without causing excessive wear.

The embodiment of the device defined in claim 10 facilitates the process of lifting the adjustable frame part because strong magnetic forces are able to act between the two frame parts and may remain active even when the electromagnets are switched off.

In the embodiment of the device specified in claim 11, the lifting device, the adjustable frame part and the magnet arrangement connected to it are disposed on a bearing plate which is displaceable relative to the stationary frame part, which enables a clear structure of the adjusting mechanism provided with different components to perform the functions needed for the adjustment process.

The fact that the adjusting mechanism is equipped with a linear drive as defined in claim 12 means that the adjustment process can be automated in combination with a programmable control unit.

In addition to providing the separation action due to repulsive magnetic forces between the parts to be conveyed, mechanical support may be provided by means of an additional separating mechanism as defined in claim 13, which acts on parts which might have become hooked with one another. The forced change in position of the parts during transport and the effect of impact-type contacts further improves the separation of the parts, even if the parts have a complicated geometry.

The invention further relates to a method of picking up ferromagnetic parts by means of a magnetic gripper, a magnetic gripper for picking up ferromagnetic parts and a manipulating device for manipulating ferromagnetic parts, as outlined in the introductory parts of claims 14, 19 and 25.

Electromagnetic grippers are often used as a means of manipulating ferromagnetic parts, by means of which the parts are removed from containers in a random position and fed to conveyor and separator systems. In order to monitor this material flow, it is useful if such magnetic grippers are equipped with systems for detecting whether parts have been picked up by it. Patent specification DD 266 788 A1 discloses an electromagnetic gripper which detects the presence of picked up parts by means of a reed switch contact which responds to the magnetic leakage flux which occurs if no parts are picked up. Other types of magnetic grippers use Hall-effect sensors to detect parts, by means of which changes in the magnetic field can be detected. These systems with sensors are very susceptible to faults under rough operating conditions.

The objective of the invention is to propose a method of picking up ferromagnetic parts, a magnetic gripper and a manipulating device, which permit extended functions and afford reliable operation but are nevertheless of a simple construction.

This objective is achieved by the invention on the basis of the features and characteristics defined in the characterising part of claims 14, 19 and 25. Always picking up a sufficient quantity of ferromagnetic parts from a quantity of parts disposed in a random position in a container using the magnetic gripper proposed by the invention constitutes the first step of the conveying and separating process, which enables the parts to be efficiently fed to the downstream conveying and separating systems. As a result of the features and characteristics defined in claims 14 and 19, picked-up parts can be reliably detected, thereby avoiding situations where the magnetic gripper runs empty. Furthermore, the invention prevents any collision with obstacles, as a result of which the feeding movement of the magnetic gripper can be brought to a halt on contact with a part on the one hand, thus protecting the components of the magnetic gripper from unnecessary mechanical stress, whilst the risk of accidents for an operator present in the working range of the magnetic gripper is minimised on the other hand. In addition, a quality reduction of the parts to be picked up caused by deformations or surface damage is largely avoided.

The method of picking up parts as well as the magnetic gripper are improved as specified in claims 15 and 20 because the contact element is moved into the initial position by a positioning element before picking up parts and is forced against a stop element. Accordingly, in addition to weight, the force applied by the positioning element also acts on the contact element, which means that the force with which the contact element is pushed from the initial position into the end position can be influenced by varying the force exerted by the positioning element. Furthermore, the method can also be implemented on the basis of a horizontal scanning direction towards the quantity of parts.

The embodiment of the method for picking up ferromagnetic parts and the magnetic gripper defined in claims 16 or 17 and 21 or 22 enable the sensitivity of the sensor system of the magnetic gripper to be adjusted. If the force exerted on the contact element by the positioning element acts in the same direction as the force of gravity as defined in claims 16 and 21, a stronger retaining force is necessary to push the contact element, which is only active when a specific number of parts has been picked up, and fix it in the end position. If, as defined in claims 17 and 22, the force exerted by the positioning element on the contact element is applied in the direction opposite the force of weight applied to the contact element, the retaining force needed to push the contact element into the end position and fix it is reduced. Consequently, parts which feel only a slight retaining force due to their geometry or the properties of their material can also be picked up and detected by the sensor system, even if the weight of the contact element exceeds the retaining forces occurring between the electro-magnet and the parts.

Another embodiment of the method is defined in claim 18, whereby the electromagnet of the magnetic gripper is not activated until the contact element has reached the end position. This enables the time during which the electro-magnet is switched on to be reduced, thereby reducing the power consumption needed to operate the magnetic gripper.

Another advantageous embodiment of the magnetic gripper is defined in claim 23 and the positioning element is provided in the form of a spring, an electric drive or a hydraulic drive. The advantage of this is that the force exerted by the positioning element on the contact element can be reproduced and is also adjustable, thereby providing an easy means of adapting the sensitivity of the sensor system to the geometry of the part and the retaining forces induced as a result.

The design of the magnetic gripper defined in claim 24 with a contact element made from a non-magnetisable material results in an uninterrupted magnetic field between the electro-magnet and the parts to be picked up, thereby resulting in stronger retaining forces between the electromagnet and parts to be picked up.

The fact that the magnetic gripper proposed by the invention is connected to a manipulating device, which may be provided in the form of a programmable portal robot in particular, as defined in claim 25, permits automated operation and flexible adaptation of the movements of the magnetic gripper needed to pick up the ferromagnetic parts.

The invention further relates to a conveyor system for conveying and separating parts in batches of different part lengths, as described in the introductory part of claim 26.

Conveyor systems for conveying and separating parts are already known, which have a longitudinal conveyor and an adjoining transverse conveyor. With these systems if necessary, it is also possible to convey parts in batches with different part lengths, and the longitudinal conveyors and transverse conveyors are dimensioned to handle the parts with the biggest dimensions and smaller parts are often not sufficiently well guided between the boundary surfaces of the transverse conveyor.

Another objective of the invention is to propose a conveyor system which is suitable for conveying parts in batches with different part lengths.

This objective is achieved by the invention on the basis of a conveyor system incorporating the features defined in independent claim 26. The advantage of this is that parts are carried by the conveyor system in batches of different lengths, separated and can then be transferred to downstream conveyor mechanisms in the correct position. In the case of the transverse conveyor constituting the second part of the conveyor system, the width of the conveyor run between two boundary surfaces can be adapted to the part length, so that short as well as long parts can be reliably conveyed with their longitudinal axis extending transversely to the conveying direction. The transfer position of the parts on the longitudinal conveyor constituting the first part of the conveyor system is also adapted to the part length, as a result of which the transfer between the longitudinal conveyor and transverse conveyor always takes place without disruption.

The embodiment of the conveyor system defined in claim 27 causes the parts of all part lengths to be guided by one end along a stationary reference plane, as a result of which a downstream conveyor system can also have a fixed reference plane and only one lateral boundary surface has to be moved in order to make the width adjustment.

The embodiment of the conveyor system defined in claim 28 with several conveyor runs of differing widths disposed adjacent to one another on the transverse conveyor is of advantage because only a small specific number of different part lengths has to be conveyed and separated by the conveyor system. During the process of reorganising the conveyor run in order to adapt to the respective part length, the width provided for the specific part length is placed in position, which can be effected by simple positioning elements without the need for a path measuring systems for positioning purposes.

The embodiment of the conveyor system defined in claim 29 is of advantage if a larger number of different part lengths has to be handled or the part lengths of the individual batches are subject to changes. Due to a stepless adjustment of the width of the conveyor run between two boundary surfaces, the conveyor system offers maximum flexibility in terms of changing the part lengths.

The conveyor system may also be of the design defined in claim 30, in which case the parts drop down from the terminal edge of the longitudinal conveyor into a pick-up portion of the transverse conveyor and are thus transferred to it.

Another option for transferring the parts from the longitudinal conveyor to the transverse conveyor is defined in claim 31 and involves transferring the parts in the region of the transfer position of the longitudinal conveyor by means of a transfer mechanism at the pick-up portion of the transverse conveyor. In this situation, the longitudinal conveyor does not have to be displaceable in the longitudinal direction but can be controlled by means of an appropriate part detection system of the transfer process on a timed basis so that the parts drop into the pick-up portion of the transverse conveyor.

The invention further relates to a part-feeding system for conveying and feeding ferromagnetic parts, of the type outlined in the introductory part of claim 32.

Another objective of the invention is to propose a part-feeding system which enables automated feeding of ferromagnetic parts separated from a random position—in the form of free-flowing material—with batches of different lengths whilst simultaneously increasing the throughput rate.

This objective is achieved by the invention on the basis of the features defined in the characterising part of claim 32. The resultant part feed system for conveying, separating and feeding ferromagnetic parts encompasses the entire sequence from taking the parts of out of the container in a random position through to feeding them to a feed position in a separated and optionally oriented position, and parts in batches of changing lengths can also be conveyed and fed in alternation. The advantageous embodiments of the resultant system components may be found in the advantages already described.

### BRIEF DESCRIPTION OF THE DRAWINGS

The invention will be described in more detail below with reference to examples of embodiments illustrated in the appended drawings. Of these:

FIG. 1 is a highly simplified diagram showing a part-feeding system proposed by the invention from a side view;

FIG. 2 is a highly simplified diagram showing a plan view of the part-feeding system proposed by the invention;

FIG. 3 is a diagram showing a section through a magnetic gripper proposed by the invention along line III-III indicated in FIG. 2;

FIG. 4 is a highly simplified diagram showing a side view of a first design variant of the conveyor system proposed by the invention;

FIG. 5 is a highly simplified diagram showing a plan view of the first design variant of the conveyor system proposed by the invention;

FIG. 5a shows a detail of the conveyor drive of the conveyor systems proposed by the invention illustrated in FIG. 5;

FIG. 6 is a highly simplified diagram showing a plan view of a second design variant of the conveyor system proposed by the invention;

FIG. 7 is a highly simplified diagram showing a device proposed by the invention for conveying and separating ferromagnetic parts, viewed in section along line VII-VII indicated in FIG. 2;

FIG. 8 is a highly simplified diagram illustrating a plan view of the device proposed by the invention for conveying and separating ferromagnetic parts with a short length dimension;

FIG. 8a is a highly simplified diagram showing a plan view of the device proposed by the invention for conveying and separating ferromagnetic parts with a long length dimension;

FIG. 9 is a cross-section of the device for conveying and separating ferromagnetic parts along line IX-IX indicated in FIG. 2.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

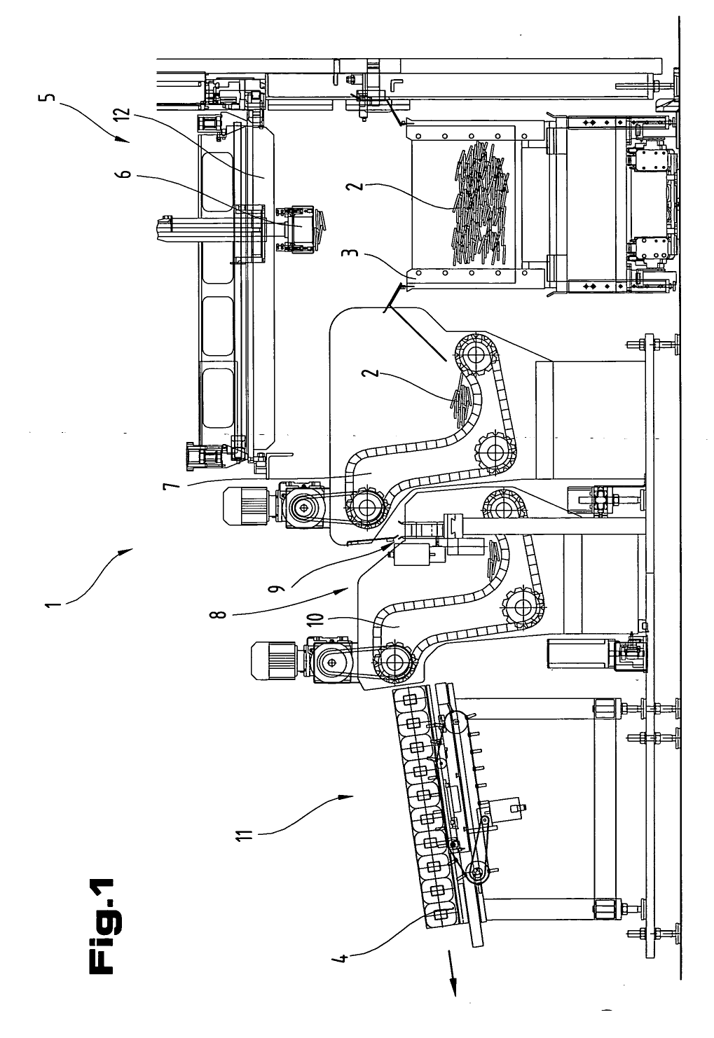

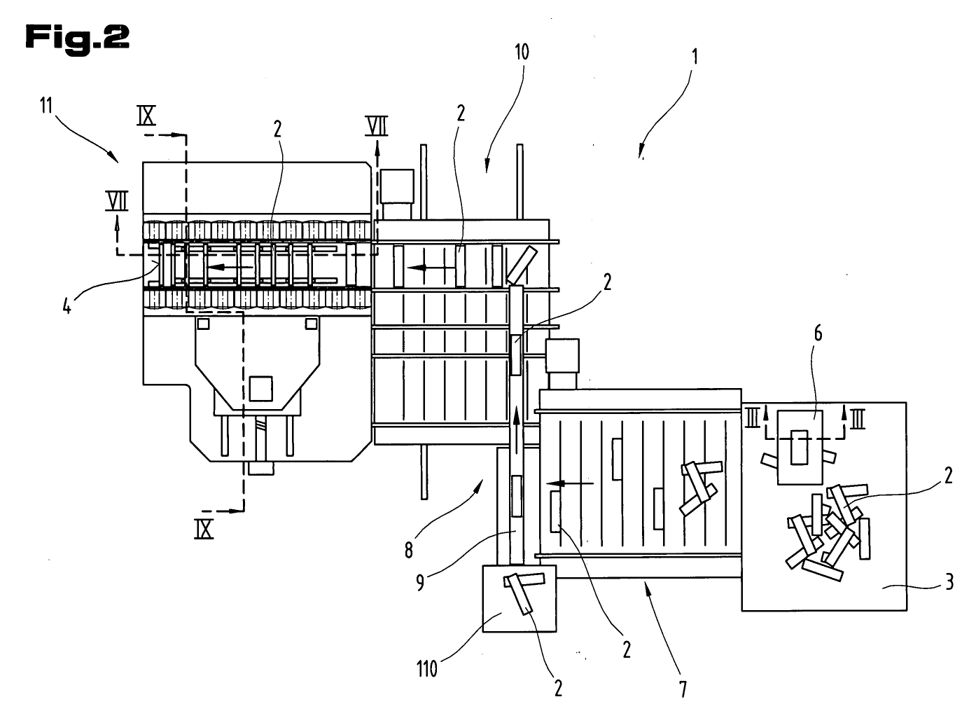

FIGS. 1 and 2 illustrate a part-feeding system 1 for conveying and feeding ferromagnetic parts 2, in particular ferromagnetic long parts, from a container 3 to a feed position 4. These long parts are usually parts of the type where the longitudinal extension is at least twice as big as the other dimensions of the parts.

This part-feeding system 1 comprises, as viewed in the transport direction, a manipulating device 5 with a magnetic gripper 6 for picking up and manipulating parts 2, adjoining it a first transverse conveyor 7 for separating and conveying parts 2 with a transfer to a conveyor system 8, consisting of a longitudinal conveyor 9 and a second transverse conveyor 10 disposed perpendicular to it. From there, the parts 2 are transferred to a device 11 for conveying and separating, from where they are fed alongside the feed position 4 for an automatic assembly system, although this is not illustrated.

The manipulating device 5 (not illustrated in FIG. 2) is a portal robot 12 with three freely programmable linear axes disposed at a right angle to one another, the working range of which extends beyond the container 3 and at least partially beyond the first transverse conveyor 7.

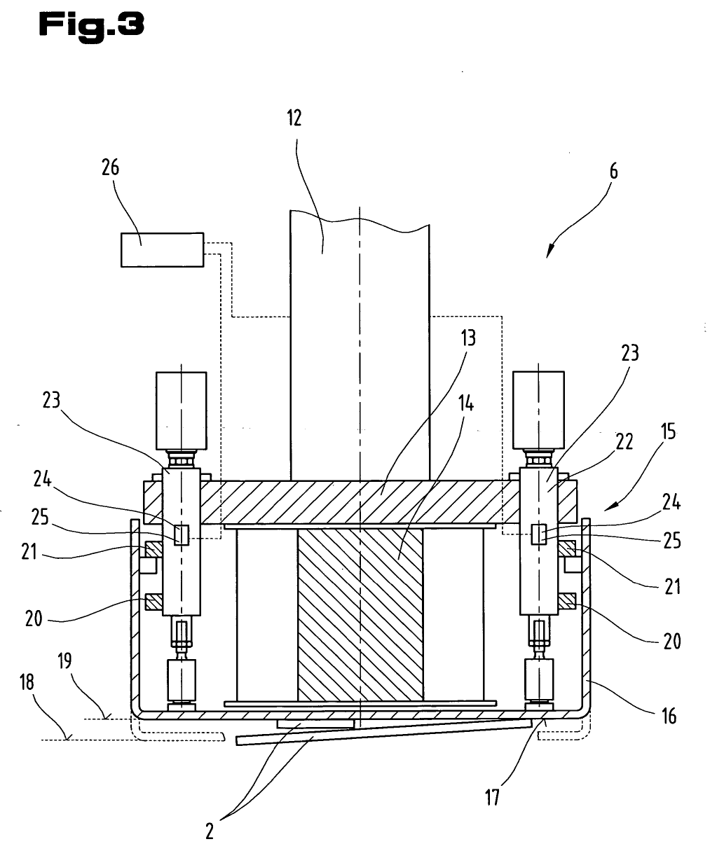

As illustrated in FIG. 3, the magnetic gripper 6 moved by the portal robot 12 (only indicated in FIG. 3) is connected to it by means of a bearing plate 13. Affixed to the bottom face of the bearing plate 13 is an electro-magnet 14 for generating a magnetic attraction force to the ferromagnetic parts 2, and if a higher conveying power is needed, several electro-magnets 14 may be used in order to increase the number of parts 2 which can be picked up in one picking cycle. The magnetic gripper 6 additionally has a sensor system 15 which is able to detect whether the magnetic gripper 6 is in a state charged with parts 2. It has a square-shaped contact element 16 surrounding the electro-magnet 14 at the bottom and sides and open at the top, which prevents a direct contact of the parts 2 with the electromagnet 14. The bottom face of the cup-shaped contact element 16 forms a pick-up surface 17, on which the parts 2 lie under the effect of a retaining force of the electromagnet 14. The pickup surface 17 may be a flat or curved surface. The contact element 16 is mounted so as to be displaceable relative to the bearing plate 13 and can be moved between an initial position 18 farther away from the electro-magnet 14—illustrated by broken lines in FIG. 3—and an end position 19 closer to the electro-magnet 14—illustrated by solid lines in FIG. 3. The initial position 18 farther away from the electro-magnet 14 is fixed by means of a first stop element 20, and the end position 19 closer to the electromagnet 14 is fixed by a second stop element 21. The moving connection between the contact element 16 and bearing plate 13 is produced by means of a positioning element 22, which in the embodiment described here is provided in the form of four hydraulic cylinders 23 disposed in the corner regions of the contact element 16. The first stop element 20 and the second stop element 21 may also be the end stops of the hydraulic cylinder 23. In other embodiments, the stop elements 20 and 21 may also be the electro-magnet 14 and/or the bearing plate 13. The positioning element 22 may also be designed with a mechanical spring or an electric linear drive in addition to the design with hydraulic cylinders 23.

The sensor system 15 also has a monitoring element 24 detecting the end position 19 and/or initial position 18 of the displaceable contact element 16. In the embodiment illustrated as an example, this is provided in the form of proximity switches 25 disposed respectively on the hydraulic cylinders 23. They are connected to a control unit 26 which, in addition to controlling operation of the magnetic gripper 6, also controls other components of the part-feeding system 1.

The method of manipulating the parts 2 by means of the manipulating device 5 will be described below with reference to FIGS. 1 and 3.

The parts 2 to be conveyed are disposed in a random position in the container 3, which is open at the top and can be positioned in the working range of the portal robot 12. In order to pick up parts 2, the empty magnetic gripper 6 is introduced into the container 3 from above by the portal robot 12 and moved close to the parts 2. When the magnetic gripper 6 is empty before making contact with the parts 2, the hydraulic cylinders 23 force the contact element 16 downwards away from the electromagnet 14 into the initial position 18 defined by the first stop element 20. In this state, the electro-magnet 14 is not switched on. As the magnetic gripper 6 is moved into position, as soon as the contact element 16 makes contact with the parts 2 by means of the pick-up surface 17, the contact element 16 is forced upwards into the end position 19 against the force exerted by the hydraulic cylinders 23. The proximity switches 25 respond on reaching the end position 19 defined by the second stop element 21 and the positioning movement is halted by the control unit 26 and the electro-magnet 14 activated in order to generate the retaining force. The magnetic gripper 6 is then lifted by the portal robot 12. The at least one part 2 attracted by the retaining force of the electro-magnet 14 pushes the contact element 16 upwards against the force generated by the hydraulic cylinders 23 into the end position 19, which can be detected by the control unit 26 because the proximity switches 25 detect the fact that the contact element 16 is still in the end position 19 during the lifting process. If the contact element 16 has been pushed back into the initial position 18 by the hydraulic cylinders 23 once the magnetic gripper 6 has been lifted and activated, this means that no part 2 was picked up during this gripping process. This is the case if, for example, the container 3 no longer contains any parts 2 at the current gripping position and the magnetic gripper 6 was pushed back by the portal robot 12 towards the base of the container 3. In this case, the portal robot 12 continues to make other gripping attempts at other positions in the container 3, under the command of the control unit 26, until at least one part 2 is picked up or there are no more parts 2. If the container 3 has been completely emptied, a signal to a user can be triggered by the control unit 26 if necessary, in which case a prompt can be issued in the form of optical or acoustic signals to enable the container to be changed.

The magnetic gripper 6 charged with one or more parts 2 is moved by the portal robot 12 above the first transverse conveyor 7 and, by deactivating the electromagnet 14, the parts 2 are transferred to the first transverse conveyor 7. The latter serves as a buffer and metering system for the adjoining conveyor system 8. In the embodiment illustrated as an example here, the detailed explanation of the first transverse conveyor 7 largely corresponds to the second transverse conveyor 10 contained in the conveyor system 8 described below but they may also be of different constructions, for example in the form of belt conveyors.

In terms of another possible detailed design of the first transverse conveyor 7 and the second transverse conveyor 10, the separating mechanism disclosed in application A 2016/2003 is also incorporated as part of the disclosure of this subject matter.

In order to run this gripping method, it is necessary to satisfy the following condition.

The retaining force obtained between the activated electro-magnet 14 and at least one ferromagnetic part 2 making contact with the pick-up surface 17 must be greater than the sum of the force produced by the weight of the contact element 16 and the force produced by the weight of the part 2 and the force exerted by the positioning element 22.

If the retaining force between the electromagnet 14 and the part 2 is less than the sum of the force produced by the weight of the contact element 16 and part 2 but greater than the force produced by the weight of the part 2, the method can nevertheless be operated by an upwardly acting force of the positioning element 22 because the force produced by the weight of the contact element 16 can be at least partially suppressed. Furthermore, by increasing the downwardly acting force exerted by the positioning element 22, the contact element 16 can be held in the end position 19 by the resultant retaining force until several parts 2 have been picked up, for example five parts 2. This enables the throughput rate of the manipulating device 5 to be increased because it is quicker to make another gripping attempt if only one part 2 which has assumed a more or less upright position in the container 2 is picked up by chance than it is to run the additional manipulation step to the first transverse conveyor 7 that would other be needed.

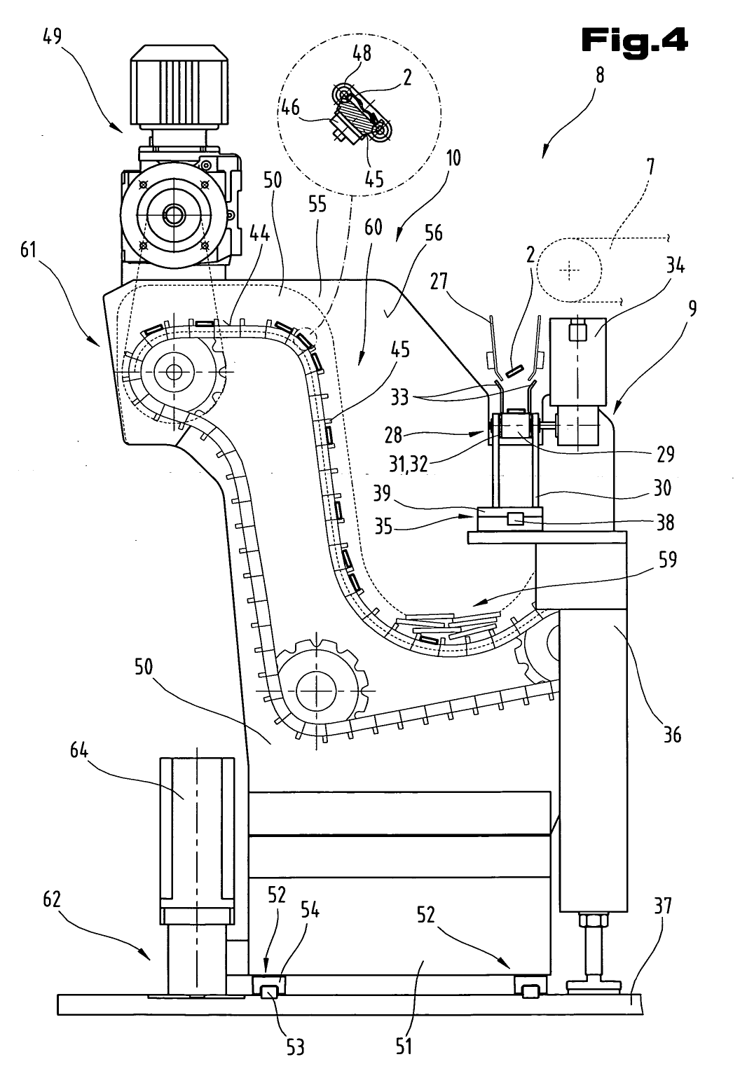

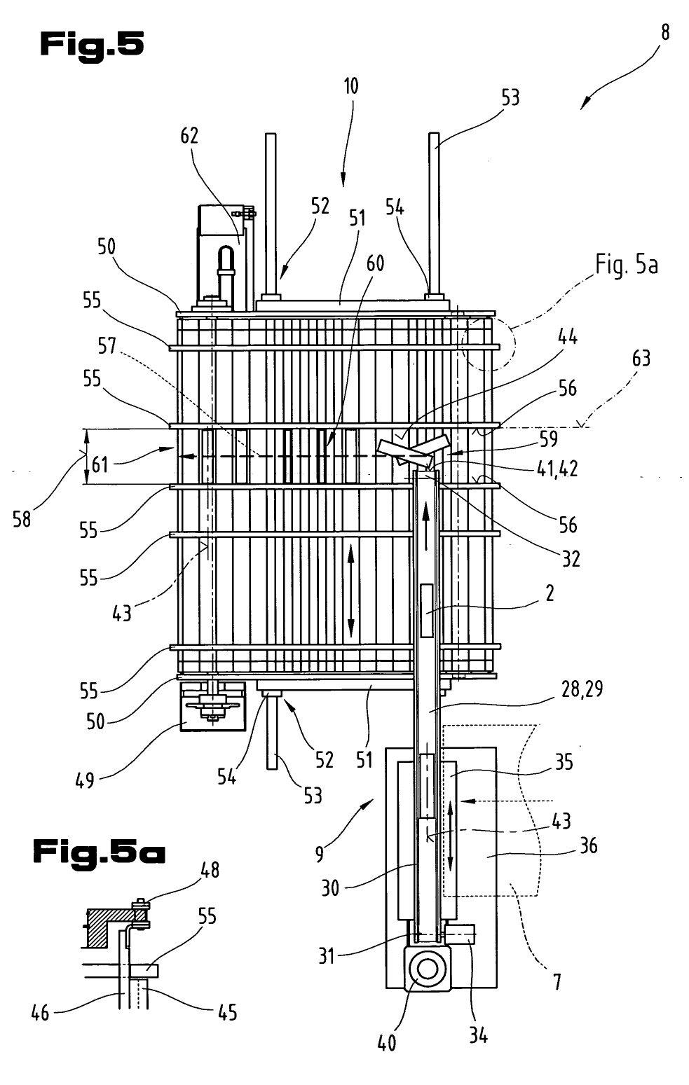

An example of an embodiment of the conveyor system 8 proposed by the invention will be described below with reference to FIGS. 4 and 5. It comprises a longitudinal conveyor 9 disposed downstream of the first transverse conveyor 7 and a second transverse conveyor 10 disposed at a right angle to it. By means of guide plates 27 disposed on the first transverse conveyor 7, the parts 2 drop in a guided manner from the first transverse conveyor 7 onto the longitudinal conveyor 9. It conveys the parts 2 horizontally and in the direction of their longitudinal axis and is disposed at a right angle to the conveying direction of the first transverse conveyor 7.

In the embodiment described, the longitudinal conveyor 9 is provided in the form of a belt conveyor 28. Accordingly, it has an endlessly circulating traction means in the form of a conveyor belt 29 and a bearing frame 30. The conveyor belt 29 is guided round a drive element 31 and a pulley element 32 mounted so as to rotate on the bearing frame 30 and is dimensioned in terms of its width so that the parts 2 can only be conveyed in the direction of their longitudinal axis. As lateral boundaries for transporting the parts, vertically upright lateral guide plates 33 are disposed on the bearing frame 30, which extend across the entire length of the longitudinal conveyor 9 and, in conjunction with the top face of the conveyor belt 29, form a transport path that is largely closed at the bottom and sides. The belt conveyor 28 is coupled with a drive 34, for example an electric motor, which is also secured to the bearing frame 30. The bearing frame 30 is mounted by means of a guide arrangement 35 so that it can be displaced in the longitudinal direction of the longitudinal conveyor 9 on a support frame 36, which is in turn secured to a base plate 37. The guide arrangement 35 comprises a guide rail 38 extending in the longitudinal direction of the longitudinal conveyor 9 and connected to the support frame 36 and a guide element 39 connected to the bearing frame 30, and the relative movement between the guide rail 38 and guide element 39 is effected by an actuator drive 40. As a result of this longitudinal displacement of the bearing frame 29, a transfer position 41 in which the parts 2 are transferred from the longitudinal conveyor 9 to the second transverse conveyor 10 is also changed. In the design variant described here, this is formed by the terminal edge 42 of the longitudinal conveyors 9 from which the parts 2 drop onto a pick-up portion of the second transverse conveyor 10 lying underneath, that will be described in more detail below.

As viewed in the conveying direction of the longitudinal conveyor 9, the transfer position 41 may also lie downstream of the terminal edge 42 or upstream of the terminal edge 42 if the longitudinal conveyor 9 does not extend as far as the front boundary surface 56 and the parts 2 are nevertheless transferred between the two boundary surfaces 56 due to the speed at which they are being conveyed on the one hand, or, on the other hand the longitudinal conveyor 9 extends beyond the rear boundary surface 56 and the parts 2 are transferred to the transverse conveyor before the terminal edge 42 by means of an appropriate device.

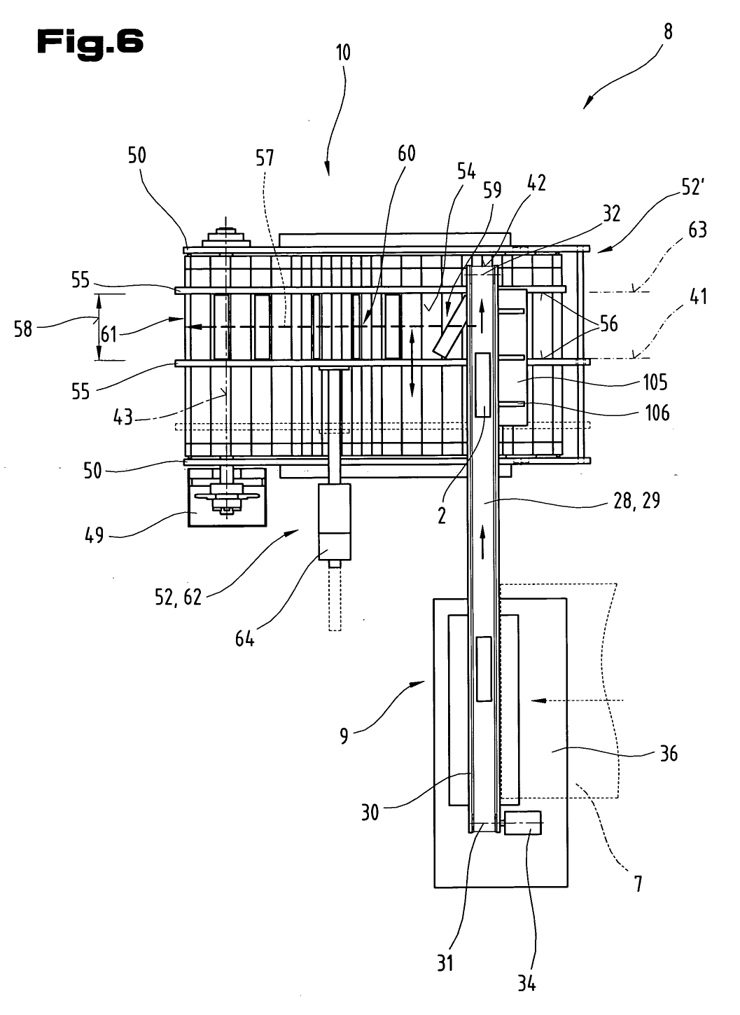

The parts 2 may also be transferred from the longitudinal conveyor 9 to the transverse conveyor 10 by means of a transfer mechanism 105 co-operating with the longitudinal conveyor 9 (as illustrated in FIG. 6), which transfers the parts 2 at the transfer position 41 from the longitudinal conveyor 9 to the transverse conveyor 10. This transfer mechanism may be provided in the form of a deflector at the respective transfer position 41, which causes the parts 2 to drop onto the transverse conveyor 10, or by an appropriately activated ram 106 (illustrated in FIG. 6), which pushes the parts 2 off the longitudinal conveyor 9 at a right angle to the longitudinal edge. In this case, the terminal edge 42 of the longitudinal conveyor 9 does not have to be displaced in order to adapt the conveyor system 8 to different part lengths, which results in a more simple construction of the longitudinal conveyor 9.

The second transverse conveyor 10 is oriented at a right angle to the longitudinal conveyor 9 and conveys and separates the parts 2 transversely to their horizontally oriented longitudinal axis 43 and has a load-bearing surface 44 formed by a plurality of strip-shaped driver elements 45 oriented horizontally and transversely to the conveying direction. The driver elements 45 are respectively secured to mutually parallel support elements 46 which are moved in the conveying direction by an endlessly circulating pulling means 47. In the embodiment described here, two traction means 47 are provided, which are formed by synchronously driven roller chains 48 with mounting flanges spaced at a distance apart transversely to the conveying direction. Extending between them are the support elements 46 and the roller chain 48 is secured respectively by one end to a mounting flange. The roller chains 48 are driven by two sprocket wheels mounted on a common drive shaft, which are coupled with a drive 49, for example an electric motor. The drive shaft as well as other pulley wheels and block elements for guiding the roller chain 48 are mounted on two side parts 50 of the transverse conveyor 10 spaced at a distance apart from one another transversely to the conveying direction, which may be of a plate-type or frame construction. The two vertically upright side parts 50 forming the base structure of the transverse conveyor 10 are secured to a moving carriage 51 which is mounted so as to be displaceable relative to the base plate 37, horizontally and transversely to the conveying direction. The guide arrangement 52 comprises two parallel, horizontal guide rails 53 oriented transversely to the conveying direction secured to the base plate 37, on which the guide elements 54 connected to the moving carriage 51 are guided.

The transverse conveyor 10 has several mutually parallel guide elements 55 spaced apart transversely to the conveying direction and extending in the conveying direction, and two respective guide elements 55 laterally bound a conveyor run 57 by means of two mutually facing boundary surfaces 56 along which the parts 2 are moved. In the embodiment of the conveyor system 8 described as an example here, there are five vertically upright, wall-shaped guide elements 55, four conveyor runs 57 extending parallel and adjacent to one another with four different widths 58 for conveying parts 2 of different part lengths. In this embodiment, four driver elements 45 of differing lengths are secured adjacent to one another on each support element 46 as viewed in the conveying direction. Distances between the driver elements 45 of differing widths form gaps in the conveying direction into which the guide elements 55 extend, and the bottom edges of the boundary surfaces 56 formed by the guide elements 55 are moved so as to lie under the load-bearing surface 44 and afford a reliable lateral guiding action for the parts 2.

The conveyor run 57 comprises respectively a pick-up portion 59 where the parts 2 picked up in a random position by the upstream longitudinal conveyor 9 are received and an adjoining separating region 60, where the parts 2 taken out of the pick-up portion 59 by the driver elements 45 are separated and conveyed onwards. Due to the arrangement of sprocket wheels and the shape of the block elements guiding the roller chain 48, the pick-up portion 59 has a concave shape open at the top so that the parts 2 are able to roll in the pick-up portion 59 until they are moved away from the quantity of parts by a driver element 45 and separated in a separating region 60 which rises steeply compared with the horizontal stretches. At an ejection position 61 at the end of the conveyor run 57, the separated parts 2 are transferred to the adjoining device 11 for conveying and separating. As viewed in the conveying direction of the longitudinal conveyor 9, every conveyor run 57 has a first front boundary surface 56 and a second, rear boundary surface 56.

In the variant of the part-feeding system 1 described here, the respective conveyor run 57 assigned to a category of parts of a specific part length is used to convey the parts 2 from the adjacently disposed conveyor runs 57 and its width 58 is dimensioned so that it is slightly bigger than the part length of the parts to be conveyed. To this end, the moving carriage 51, controlled by the control unit 26, is positioned by means of an adjusting mechanism 62 so that the rear boundary surface 56, as viewed in the conveying direction of the longitudinal conveyor 9, of the conveyor run 57 currently being used coincides with a stationary reference plane 63 necessary for transferring the parts to downstream conveyor systems. The front boundary surface as viewed in the conveying direction of the longitudinal conveyor lies within the distance of the width 58 of the conveyor run 57 in front of the stationary reference plane 63. The adjusting mechanism 62 in the embodiment described here comprises the moving carriage 51 with the guide elements 55 disposed on it as well as a drive 64, which is provided in the form of an electric motor for example.

FIG. 6 illustrates another design variant of the conveyor system 8. In this variant, in order to adapt the second transverse conveyor 10 to the part length, the width 58 of the conveyor run 57 is changed by adjusting the distance between the boundary surfaces 56 formed by the guide elements 55. The guide element 55 forming the rear boundary surface 56 as viewed in the conveying direction of the longitudinal conveyor 9 in this embodiment is disposed in a fixed position by reference to the rear side part 50 and the rear boundary surface 56 coincides with the stationary surface 63. The guide element 55 forming the front boundary surface 56 as viewed in the conveying direction of the longitudinal conveyor 9 in this embodiment can be adjusted transversely to the conveying direction relative to the stationary guide element 55 by means of the adjusting mechanism 62. The adjustable guide element is guided along the adjustment path by means of the guide arrangement 52, which is contained in the adjusting mechanism 62. As an alternative or in addition, however, a separate guide arrangement 52′ could be provided, for example comprising guide bars secured by their ends to the oppositely lying side parts above the load-bearing surface 44 and along which the adjustable guide element 55 is guided during the adjusting movement. Due to the fact that only one respective continuous driving member 45 is provided on a support element 46 in this variant of the second transverse conveyor 10, the adjustable guide element 55 is not guided as far as underneath the load-bearing surface 44. In order to provide the conveyor run 57 with a reliable end termination nevertheless, a chain-type terminating element is provided on the bottom edge of the adjustable guide element 55, although this is not illustrated, with links, the shape of which is the negative of a driver element, and these links engage in recesses of the driver element so that they move the lateral boundary surface of the adjustable guide element 55 as far as the load-bearing surface. The adjusting mechanism 62 also has a drive 64 which effects the adjusting movement. The width 58 of the conveyor run 57 in this embodiment is also adjusted under the control of the control unit 26.

In addition to the embodiments described so far, in which the rear boundary surface 56 as viewed in the conveying direction of the longitudinal conveyor 9 coincides with a stationary reference plane 63 during conveying, the front boundary surface 56 as viewed in the conveying direction of the longitudinal conveyor 9 may also coincide with the stationary reference surface 63. In this case, the rear guide element 55 as viewed in the conveying direction of the longitudinal conveyor 9 must then be moved into a position which determines the requisite width 58 of the conveyor run 57.

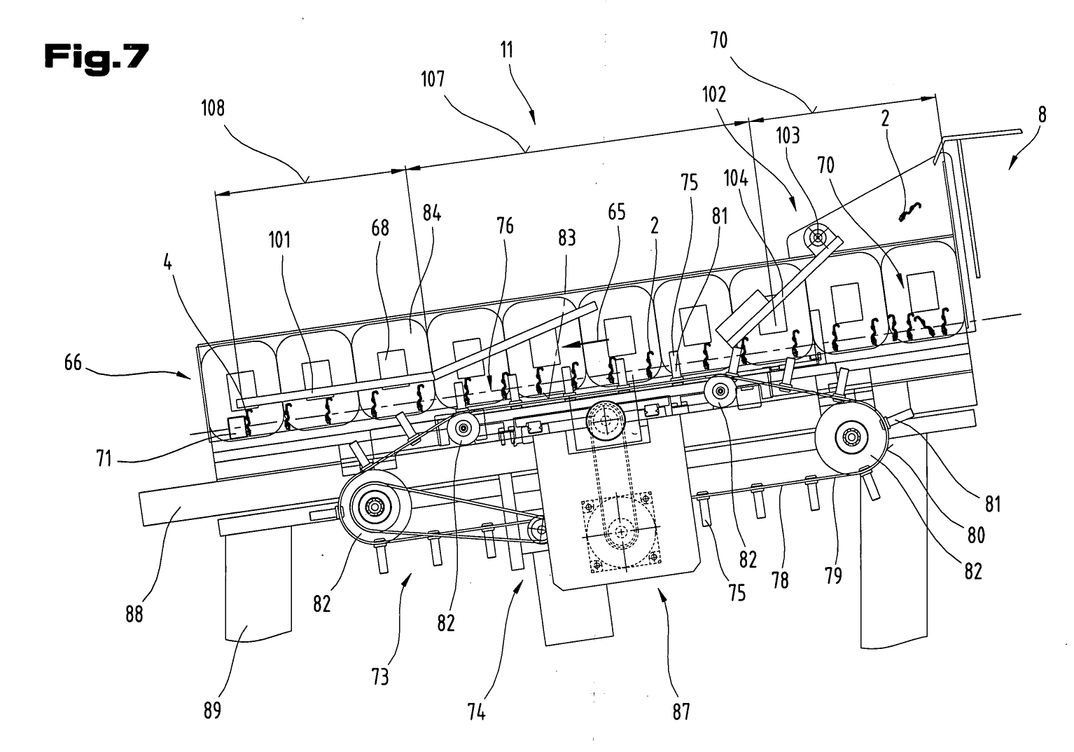

The device 11 for conveying and separating ferromagnetic parts 2 illustrated in FIGS. 7, 8, 8a and 9 adjoins the conveyor system 8 and also conveys the parts 2 with their longitudinal axis horizontally and oriented transversely to the conveying direction—indicated by arrow 65. To this end, the device 11 has two magnet arrangements 66 disposed horizontally, transversely to the conveying direction at a distance from one another, which are provided as the same type of electromagnets or permanent magnets and form a conveyor run 67 between them, along which a magnetic field is generated continuously through the parts 2 to be conveyed by mutually facing poles 68 of the magnet arrangements 66. Mutually facing poles 68 of the two oppositely lying magnet arrangements 66 are of different types—a north pole lies opposite a south pole—as a result of which the magnetic field lines run in a substantially straight line from one magnet arrangement 66 to the oppositely lying magnet arrangement 66. The conveyor run 67 extending between the two magnet arrangements 66 disposed at a distance 69 apart from one another extends from an infeed portion 70, in which the parts 2 transferred from the upstream conveyor system 8 are picked up, to the feed position 4 disposed at the end of the conveyor, which is fixed by two stops 71. From the feed position 4, the parts 2 are removed by a manipulating device, not illustrated, and conveyed onwards. The conveyor run 67 is bounded by support elements 72 at the bottom in the region of the magnet arrangements 66, which prevents the parts 2 from falling as they are being conveyed, for example if the magnetic field becomes ineffectual due to a fault or power failure. During the conveying process, the ferromagnetic parts 2 move within the magnetic field created by the two magnet arrangements 66 which penetrates them. Due to the action of the magnetic field, all the parts 2 are magnetised in the same manner, as a result of which repulsive forces occur between the magnetised parts 2 causing them to separate. The magnetic field in the described embodiment is set so that it is so intensive that the parts 2 are in a state in which they hover above the support elements 72 so that the parts 2 are conveyed along the device for conveying and separating 11 or conveyor run 67 largely without any friction. However, it would also be possible for the parts 2 not to be placed in a fully hovering state by the magnetic field, in which case they will make at least partial contact with the support elements 72. In the embodiment described here, the conveyor run 67 from the infeed portion 70 to the feed position 4 descends by reference to a horizontal line and creates a motion force component acting on the parts 2 in the direction of the feed position 4 due to gravity. A repulsive force component acts between the part 2 making contact with the stop 71 disposed in the feed position 4 and the part 2 behind, due to the fact that they are magnetised in the same direction, which increases as the mutual distance between these two parts 2 becomes shorter. The part 2 behind draws closer to the part 2 disposed in the feed position 4 until the repulsive forces of the adjacent parts 2 are in equilibrium due to the movement force component in the conveying direction caused by gravitational force. A force equilibrium is established in the same way between all parts 2 disposed in the active range of the magnetic field, provided the movements are not restricted by other influences, such as obstacles or other fixing mechanisms, for example, by means of which the positions of the parts 2 can be temporarily fixed.

In order to convey the parts 2 in a controlled manner along the conveyor run 67, the device 11 for conveying and separating has a conveying mechanism 73 in the region of the conveyor run 67. It comprises a drive 74 and several separating elements 75 disposed equidistantly in the conveying direction and displaceable along the conveyor run 67 by means of the drive 74, and these sub-divide the conveyor run 67 into several consecutive receiving regions 76 in the conveying direction, each of which is designed to accommodate at least one part 2. The conveying mechanism 73 is provided in the form of an endlessly circulating traction drive 77 with at least one traction means 78 to which the separating elements 75 are secured. In the embodiment described here, two traction means 78 are provided in the form of two horizontal and parallel flat belts 79 spaced at a distance apart from one another transversely to the conveying direction. Distributed across their peripheral surface 80 are separating elements 75 in the form of bolts 81 projecting beyond the periphery in a substantially vertical arrangement, the length of which is selected so that the movement of the parts 2 is restricted by the bolts 81. The parallel distance between the two flat belts 79 extending parallel is shorter than the longitudinal extension of the parts 2, as a result of which the latter are retained in the respective receiving region 76 by the bolts 81 as they move along the conveyor run 67. In this embodiment of the part-feeding system 1, the conveyor run 67 extends in a straight line and descends slightly with respect to a horizontal line because the parts 2 are guided into the receiving regions 76, although the conveyor run 67 may also have horizontal portions or portions rising with respect to the horizontal line, in which case the conveying function would not be possible without the receiving regions 76 proposed by the invention, for example accommodating an individual part 2, in the form of the separating elements 75.

As may be seen from FIG. 7, the infeed portion 70 is adjoined by a guide portion 107 and a discharge portion 108 as viewed in the conveying direction. The guide portion 107 comprises the part of the conveyor run 67 in which the separating elements 75 project into the conveyor run 67 and sub-divide it into the receiving regions 76. Consequently, the separating elements 75 are not guided by the pulling means 78 across the entire length of the conveyor run 67 but only along the guide portion 107 between the infeed portion 70 and discharge portion 108. The length of the individual portions in the active range of the magnetic field is dependent on the total length of the conveyor run 67, and the length of the infeed portion and discharge portion in the embodiment described here corresponds to approximately four times the distance between two immediately consecutive separating elements 75 as viewed in the conveying direction. Depending on the total length of the conveyor run 67, the length of the guide portion is typically between 30% and 95% of the length of the conveyor run 67, which means that part runs of the conveyor run 67 in the infeed portion 70 and in the discharge portion 108 remain without the engagement of the separating elements 75 and correspond to at least twice the distance between two immediately consecutive separating elements 75. In the infeed portion 70, this facilitates separation of the parts 2 because the movements of the parts 2 along the conveyor run 67 caused by the mutually repelling forces are not obstructed by the separating elements 75 and the parts 2 can be distributed uniformly in this portion. At the changeover from the infeed portion 70 to the guide portion 107, the flat belts 79 incorporating the bolts 81 are guided from underneath onto the conveyor run by means of pulley elements 82 and the bolts 81 are pivoted into the conveyor run so that they form the receiving regions 76 which can be displaced in the conveying direction. The length of a receiving region 76 defined by the distance between two consecutive bolts 81 is selected so that at least one part 2 can be accommodated and guided in a receiving region 76.

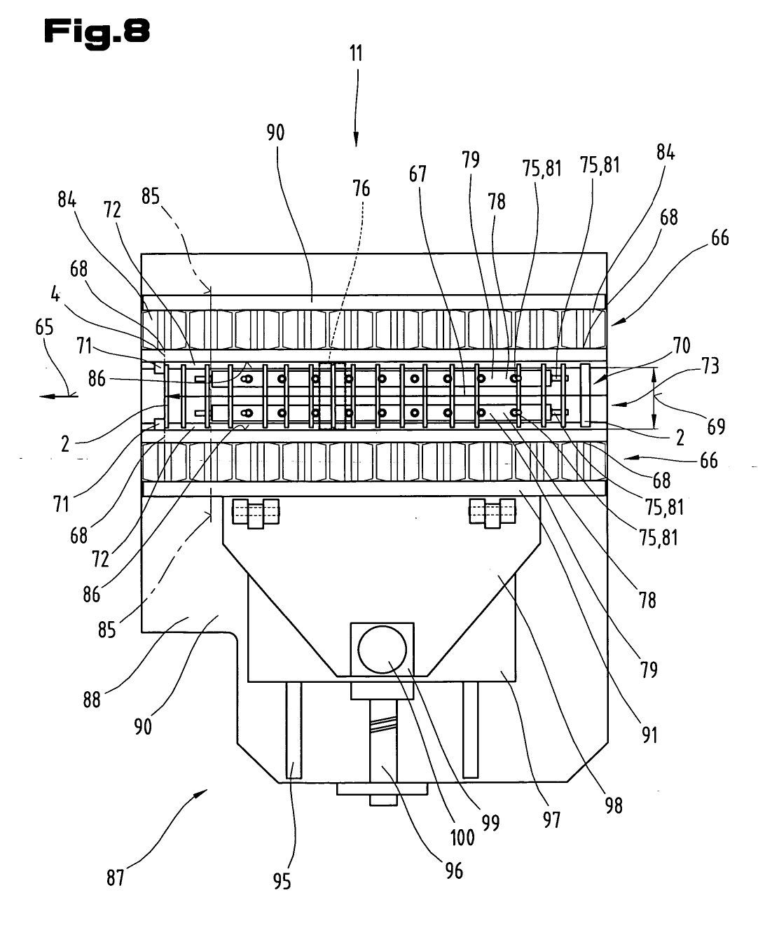

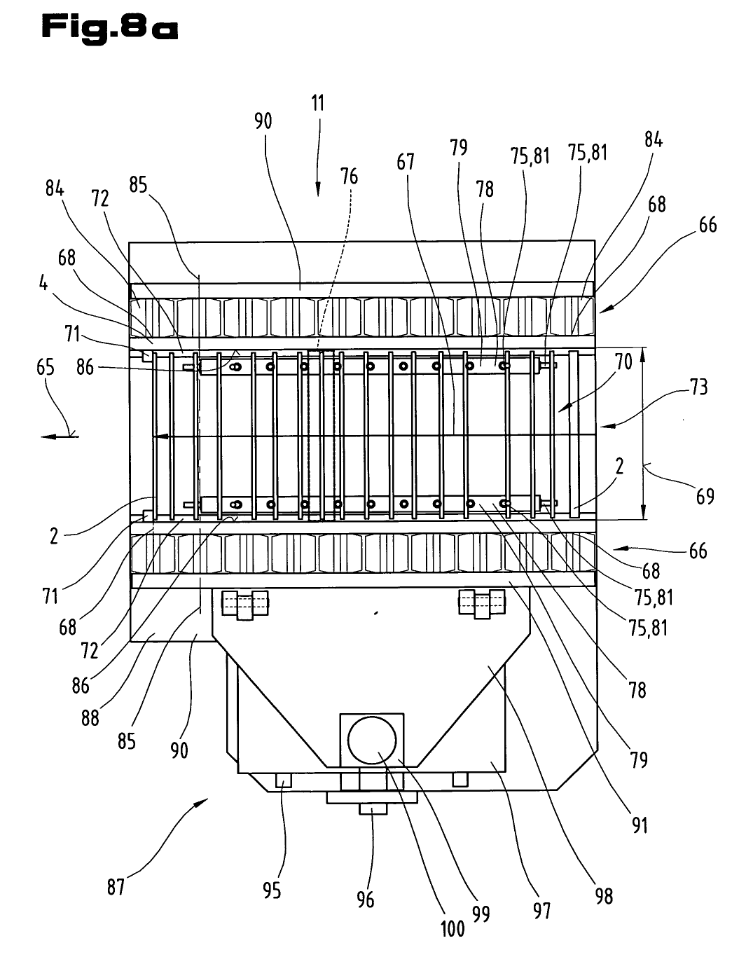

As may be seen from FIG. 8, in the embodiment described as an example, two or also more than two parts 2 may be guided in a receiving region 76 if the distance between two consecutive separating elements 75 is big enough. At the changeover from the guide portion 107 to the discharge portion 108, the flat belt 79 incorporating the bolts 81 is fed back downwards out of the conveyor run 67 by the pulley elements 82 and the bolts 81 are pivoted out of the conveyor run so that the parts 2 can be uniformly distributed again in the portion as far as the feed position 4 without their movement being restricted by the separating elements 75 or bolts 81. The top faces of the support elements 72 and pulling means 78 of the conveying mechanism 73 form a conveying surface 83, some portions of which run in a horizontal plane or at an incline with respect to the horizontal. However, the conveying mechanism 73 may also incorporate parts in the form of a conveyor screw, in which case the axis of rotation of the conveyor screw is disposed underneath the conveying surface 83 and parallel with the conveying direction and only segments of the screw surface projecting beyond the conveying surface 83 into the conveyor run 67 constitute the separating elements 75.

In the embodiment described here, the conveying surface 83 is inclined downwards with respect to the horizontal in the conveying direction. In other embodiments of the part-feeding system 1, the conveying surface 83 may also be curved and may rise with respect to the horizontal. The magnet arrangements 66 lying opposite one another in the embodiment described here each contain several electromagnets 84 disposed one after the other in the conveying direction. These are respectively disposed so that a mid-axis 85 of an electromagnet 84 is more or less aligned with the mid-axis 85 of an electro-magnet 84 on the oppositely lying magnet arrangement 66 and the poles 68 facing one another are different. As a result, the magnetic field lines between the oppositely lying electromagnets 84 run largely parallel with their mid-axes 85, so that the parts 2 are oriented with their longitudinal axis substantially transversely to the conveying direction. The magnet arrangements 66 lying opposite one another transversely to the conveying direction form lateral boundaries 86 for the receiving regions 76, in which case the boundary surfaces may be respectively provided in the form of a metal sheet or a metal plate extending across all the electro-magnets 84 of a magnet arrangement 66. In order to adapt the device 11 for conveying and separating to accommodate different part lengths, the oppositely lying magnet arrangements 66 are adjusted in terms of their distance relative to one another by means of an adjusting mechanism 87. e.g. from the setting illustrated in FIG. 8 for parts 2 with a shorter length dimension to the setting illustrated in FIG. 8a for parts 2 with a long length dimension.

In order to intensify the magnetic fields acting between the magnet arrangements 66, the poles 68 of the electromagnets 84 of the oppositely lying magnet arrangements 66 facing away remote from the conveyor run 67 are connected to one another so as to be electromagnetically conductive by means of a frame 88 made from ferromagnetic material.

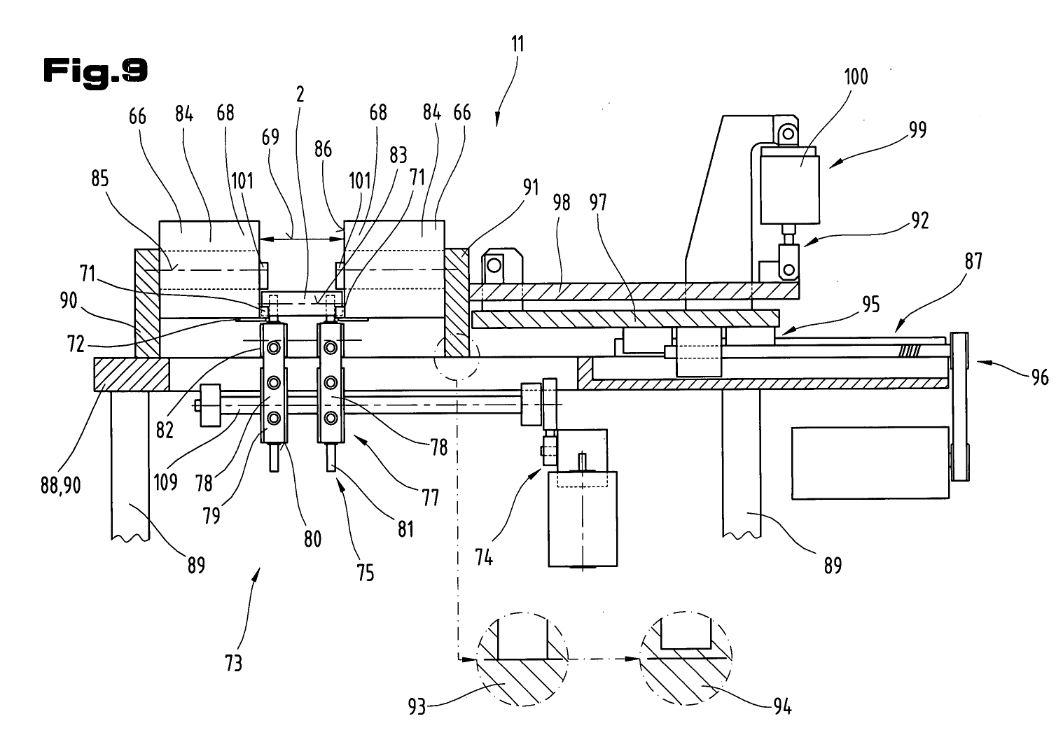

Supported above a bearing frame 89 on the base plate 37, the frame 88 comprises a stationary frame part 90, on which a first magnet arrangement 66 is disposed, and an adjustable frame part 91, on which a second magnet arrangement 66 is disposed. The adjustable frame part 91 can be displaced by means of a lifting mechanism 92 between an initial position 93 in contact with the stationary frame part 90 and an operating position 94 raised from the stationary frame part 90—respectively illustrated as a detail in FIG. 9. In order to set the distance 69 between the magnet arrangements 66, the adjustable frame part 91 and the lifting mechanism 92 are disposed on a bearing plate 97 which can be displaced relative to the stationary frame part 90 by means of the guide arrangement 95 and linear drive 96. The lifting mechanism 92 comprises a pivot plate 98 and an actuator element 99 which pivots the pivot plate 98 relative to the bearing plate 97 about a horizontal axis extending parallel with the conveying direction. In the embodiment illustrated, the actuator element 99 is provided in the form of a hydraulic cylinder 100. As a result of the movement of the pivot plate 98 effected by the actuator element 99, the adjustable frame part 91 is transferred, together with the magnet arrangement 66 affixed to it, from the initial position 93 in contact with the stationary frame part 90 into the operating position 94 raised from the stationary frame part 90. In order to adjust the distance 69 between the two magnet arrangements 66 when adapting to a different part length, all the parts 2 contained in the device 11 are removed from the feed position 4, the electro-magnets 84 are deactivated, the adjustable frame part 91 is raised into the operating position 94 by means of the pivot plate 98 and actuator element 99 and then the bearing plate 97 is displaced by the linear drive 96 along the guide arrangement 95 transversely to the conveying direction. After making the adjustment, the adjustable frame part 91 is returned to the initial position 93 by means of the pivot plate 98 and actuator element 99 and the electro-magnets 84 are then activated again.

When adjusting the distance 69 between the magnet arrangements 66—e.g. from the setting illustrated in FIG. 8 for parts 2 with a short length dimension to the setting illustrated in FIG. 8a for parts 2 with a big length dimension—at the same time as the adjustable frame part 91 is adjusted, the flat belt 79 adjacent to it with the separating elements 75 mounted on it is likewise adjusted in the same way as the distance 69. To this end, the pulley elements 82 of the adjustable flat belt 79 are moved on common shafts 109 relative to the pulley elements 82 of the stationary flat belt 79, and the pulley elements 82 co-operating with the adjustable flat belt 79 are advantageously mounted on a bearing frame, although this is not illustrated, as a result of which all the pulley elements 82 of the adjustable flat belt 79 are adjusted in a simultaneous and synchronous movement if the bearing frame is coupled with the adjustable bearing plate 97. The shaft 109 connected to the drive 74 may be provided in the form of a splined shaft, thereby providing a connection to the pulley elements 82 of the adjustable flat belt 79 which has a fixed torque but is easy to displace axially.

In order to adapt the magnetic field to different part lengths, the electrical supply voltage of the electromagnets 84 is adjusted by means of the control unit 26. At a constant magnetic field intensity when the parts 2 are hovering, the vertical distance between the longitudinal axis of the parts 2 and the mid-axes 85 of the electro-magnet 84 is greater in the case of heavier parts 2 than it is in the case of lighter parts 2 due to the higher weight. Consequently, by varying the magnetic field intensity, a specific distance can be set between the bottom edges of the hovering parts 2 to be conveyed and the conveying surface 83 formed by the support elements 72, and the magnetic field intensity is increased for heavier parts 2, as a result of which the longitudinal axes of the parts 2 will be raised closer towards the plane of the mid-axes 85, whilst in the case of lighter parts 2, the magnetic field intensity is reduced, as a result of which the longitudinal axes of the parts 2 is lowered with respect to the plane of the mid-axes 85. Consequently, the hovering state of the parts 2 can easily be acted on by varying the electrical supply voltage of the electromagnets 84. The supply voltage can advantageously be steplessly adjusted by a circuit network part incorporated in the control unit 26.

In the discharge portion 108 of the conveyor run 57, the parts 2 are vertically guided by means of two bar-shaped baffle elements 101. As a result and because of the stop 71, the parts 2 are fed into the feed position 4 in a defined disposition.

In order to assist the process of separating the parts 2, the device 11 for conveying and separating also has a separating mechanism 102 (illustrated in FIG. 7) in the region of the conveyor run 67, which has at least one lever 104 mounted on a pivot axis 103 extending horizontally and at a right angle to the conveying direction. Accordingly, the pivot axis 103 may be disposed on the stationary frame part 90 and/or the adjustable frame part 91. The lever 104 projects with its free end into a receiving region 76 accommodating the parts 2 and pushes, at least with its own weight, onto the parts 2 fed past its free end by the conveying mechanism 73. A slight tilting movement is therefore imparted to the parts 2 in addition to the conveying movement, so that any parts 2 which have become hooked on one another can be detached. In addition, the lever 104 is temporarily deflected upwards by the separating elements 75 as they are moved past it and then moves downwards under its own weight onto parts 2 contained in the receiving region 76. These impact-type contacts likewise help to separate parts 2 that have become adhered on one another or hooked with one another. In order to intensify the separating action, several levers 104 may be provided one after the other in the conveying direction and/or adjacent to one another transversely to the conveying direction.

The part-feeding system 1 also has several sensors connected to the control unit 26, by means of which the process of conveying parts along the first transverse conveyor 7, the longitudinal conveyor 9, the second transverse conveyor 10 and the device for conveying and separating 11 is monitored, so that if a drop below a settable minimum number of parts is detected by a sensor, the individual upstream conveyor units of the part-feeding system 1 can be activated by the control unit 26 if necessary. These sensors monitor at least the feed position 4, the infeed portion 70 of the device 11 for conveying and separating and the pickup portion 59 of the second transverse conveyor 10.

A simple description will now be given of the method of switching the part-feeding system 1 from a part length a to a different part length b.

In order to effect the movements necessary for this changeover process, all the parts 2 of part length a are removed from the conveyor paths of the part-feeding system 1 in a first step. This can be done by conveying all the parts 2 one after the other as far as the feed position 4 and removing them by means of a manipulator of an assembly system, although this is not illustrated. In order to reduce the time needed to run the part-feeding system 1 empty, another option is to provide a means of gating out at least some of the parts 2 upstream of the feed position 4, in which case, for example, the parts 2 transferred from the first transverse conveyor 7 to the longitudinal conveyor 9 are not transferred from the latter to the second transverse conveyor 10 and instead, the parts to be gated out are conveyed to a container 1 10 by reversing the conveying direction of the longitudinal conveyor 9 and the parts already in the second transverse conveyor 10 are gated out at the feed position 4. This configuration of two simultaneously running gating process enables the time needed to run the part-feeding system 1 empty by about half and therefore significantly reduces it. By using appropriate sensors to detect the parts in the individual conveyor units of the part-feeding system 1, the part-free state can be detected without the need for an operator to carry out checks.

The requisite setting procedures for the system components are then carried out as followed.

At the device for conveying and separating 11, the supply voltage of the electromagnets 84 is interrupted and the magnetic field deactivated as a result, apart from any residual magnetism. In order to carry out the adjustments, the conveying mechanism 73 may likewise be switched off if necessary. The adjustable frame part 91 with the magnet arrangement 66 affixed to it is then raised by means of the lifting mechanism into the operating position 94 raised from the stationary frame part 90. The adjustable frame part 91 is then moved by the adjusting mechanism 87 horizontally and transversely to the conveying direction until the distance 69 between the two oppositely lying magnet arrangements 66 is slightly bigger than the current part length b of the parts 2 to be conveyed. Once this position has been reached, the adjustable frame part 91 is moved into the initial position 93 and is thus in contact with the stationary frame part 90, as a result of which the poles 68 of the two oppositely lying magnet arrangements 66 facing away from the conveyor run are connected by ferromagnetic components so as to be electromagnetically conductive again. Once the electromagnets 84 have been activated by switching on the electric supply voltage and running up the conveying mechanism 73, the device for conveying and separating 11 is ready to accommodate parts of a part length b.

When making the adjustment in the case of the second transverse conveyor 10, the conveyor run 57 with the width 58 between the boundary surfaces 56 specifically selected to accommodate the part length b is selected and moved into position. To this end, the moving carriage 51 with the guide elements 55 disposed on it is moved by means of the adjusting mechanism 62 horizontally and transversely to the conveying direction until the rear boundary surface 56, as viewed in the conveying direction of the longitudinal conveyor 9, of the selected conveyor run 57 coincides with the stationary reference surface 63 which is fixed by the boundary 86 formed by the stationary magnet arrangement 66. In this position, the conveyor run 67 of the device for conveying and separating 11 constitutes the extension of the conveyor run 57 of the second transverse conveyors 10 as seen in plan view because the distance 69 between the boundaries formed by the magnet arrangements 66 corresponds to the width 58 between the boundary surfaces 56 of the selected conveyor run 57 (see FIG. 2).

When making the changeover from part length a to part length b, the longitudinal conveyor 9 is adjusted so that the transfer position 41 lies above the selected conveyor run 57 of the second transverse conveyor. To this end, the longitudinal conveyor 29 is moved along the guide arrangement 35 by means of the actuator drive 40 in the direction of its longitudinal axis until its terminal edge 42 extends at least as far as the front boundary surface 56 of the second transverse conveyor 10 as viewed in the conveying direction or slightly beyond it so that the parts 2 are guaranteed to drop into the pick-up portion 59 of the second transverse conveyor 10. The movement of the conveyor belt 29 may be temporarily halted when carrying out the adjustment procedures if necessary.

The first transverse conveyor 7 may not require any modification for a change of part length because its conveying width is fixed and its dimension is chosen on the basis of the largest part length to be conveyed.

The manipulating device 5 likewise requires no adjustment for a change of part length, although the container with the parts to be conveyed may be automatically changed if necessary, in which case the container with part length a is transported away from the working range of the portal robot 12 and replaced by a container with part length b, which is transported from a waiting position into the working range of the portal robot by means of a conveyor system.

The sequence control for the part-feeding system 1 is advantageously handled by the control unit 26, which may in turn be a constituent part of a higher-ranking production control system, and may contain all the part systems for inputting data and signals, programme control, function control and data and signal output known from the prior art.

The embodiments illustrated as examples represent possible design variants of the part-feeding system and it should be pointed out at this stage that the invention is not specifically limited to the design variants specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the design variants described and illustrated are possible and fall within the scope of the invention.

For the sake of good order, finally, it should be pointed out that, in order to provide a clearer understanding of the structure of the part-feeding system, it and its constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1, 2; 6; 7, 8, 9 constitute independent solutions proposed by the invention in their own right. The objectives and associated solutions proposed by the invention may be found in the detailed descriptions of these drawings.

List of reference numbers

| | |
|---|---|
| 1 | Part-feeding system |
| 2 | Part |
| 3 | Container |
| 4 | Feed position |
| 5 | Manipulating device |
| 6 | Magnetic gripper |
| 7 | Transverse conveyor |
| 8 | Conveyor system |
| 9 | Longitudinal conveyor |
| 10 | Transverse conveyor |
| 11 | Device |
| 12 | Portal robot |
| 13 | Bearing plate |
| 14 | Electro-magnet |
| 15 | Sensor system |
| 16 | Contact element |
| 17 | Pick-up surface |
| 18 | Initial position |
| 19 | End position |
| 20 | Stop element |
| 21 | Stop element |
| 22 | Positioning element |
| 23 | Pneumatic cylinder |
| 24 | Monitoring element |
| 25 | Proximity switch |
| 26 | Control unit |
| 27 | Baffle plate |
| 28 | Belt conveyor |
| 29 | Conveyor belt |
| 30 | Bearing frame |
| 31 | Drive element |
| 32 | Pulley element |
| 33 | Guide plate |
| 34 | Drive |
| 35 | Guide arrangement |
| 36 | Support frame |
| 37 | Base plate |
| 38 | Guide rail |
| 39 | Guide element |
| 40 | Actuator drive |
| 41 | Transfer position |
| 42 | Terminal edge |
| 43 | Longitudinal axis |
| 44 | Load-bearing surface |
| 45 | Driver element |
| 46 | Support element |
| 47 | Pulling means |
| 48 | Roller chain |
| 49 | Drive |
| 50 | Side part |
| 51 | Moving carriage |
| 52 | Guide arrangement |
| 53 | Guide rail |
| 54 | Guide element |
| 55 | Guide element |
| 56 | Boundary surface |
| 57 | Conveyor run |
| 58 | Width |
| 59 | Pick-up portion |
| 60 | Separating region |
| 61 | Ejector position |
| 62 | Adjusting mechanism |
| 63 | Reference line |
| 64 | Drive |
| 65 | Arrow |
| 66 | Magnet arrangement |
| 67 | Conveyor run |
| 68 | Pole |
| 69 | Distance |
| 70 | Infeed portion |
| 71 | Stop |
| 72 | Support element |
| 73 | Conveying mechanism |
| 74 | Drive |
| 75 | Separating element |
| 76 | Receiving region |
| 77 | Traction drive |
| 78 | Traction means |
| 79 | Flat belt |
| 80 | Peripheral surface |
| 81 | Pin |
| 82 | Pulley element |
| 83 | Conveying surface |
| 84 | Electro-magnet |
| 85 | Mid-axis |
| 86 | Boundary |
| 87 | Adjusting mechanism |
| 88 | Frame |
| 89 | Bearing frame |
| 90 | Frame part |
| 91 | Frame part |
| 92 | Lifting mechanism |
| 93 | Initial position |
| 94 | Operating position |
| 95 | Guide arrangement |
| 96 | Linear drive |
| 97 | Bearing plate |
| 98 | Pivot plate |
| 99 | Actuator element |
| 100 | Pneumatic cylinder |
| 101 | Baffle element |
| 102 | Separating mechanism |
| 103 | Pivot axis |
| 104 | Lever |
| 105 | Transfer mechanism |
| 106 | Ram |
| 107 | Guide portion |
| 108 | Discharge portion |
| 109 | Shaft |
| 110 | Container |

1. Device for conveying and separating ferromagnetic parts, in particular long parts, in a conveying direction extending transversely to the longitudinal axis of the parts, comprising at least two magnet arrangements disposed on a frame, spaced apart from one another transversely to the conveying direction and forming a conveyor run extending between them in the conveying direction from an infeed portion to a feed position, with poles of a different type facing one another which create a magnetic field penetrating the parts to be conveyed in order to separate the parts by mutual repulsion, wherein a conveying mechanism is disposed in the region of the conveyor run incorporating separating elements disposed at a distance apart from one another in the conveying direction which can be moved along the conveyor run in the active range of the magnetic field by means of a drive, which sub-divide the conveyor run into several consecutive receiving regions which respectively guide at least one part if necessary.

2. Device as claimed in claim 1, wherein the separating elements are guided by the conveying mechanism between the magnet arrangements along a guide portion and the latter is shorter than the conveyor run.

3. Device as claimed in claim 1, wherein the conveying mechanism is provided in the form of an endlessly circulating traction drive and has at least one traction means which is equipped with the separating elements.

4. Device as claimed in claim 3, wherein the separating elements project more or less vertically on an outer peripheral surface of the pulling means.

5. Device as claimed in claim 1, wherein the conveying mechanism forms a conveying surface, some portions of which run at an incline upwards or downwards with respect to a horizontal line or extend in a horizontal plane.

6. Device as claimed in claim 1, wherein the magnet arrangements respectively include at least one electro-magnet and mid-axes of the oppositely lying electro-magnets extend more or less in alignment with one another.

7. Device as claimed in claim 1, wherein the magnet arrangements lying opposite one another transversely to the conveying direction form lateral boundaries for the receiving regions and can be adjusted relative to one another in terms of their distance by means of an adjusting mechanism.

8. Device as claimed in claim 1, wherein the frame is made from ferromagnetic material and the poles of the oppositely lying magnet arrangements facing away from the conveyor run are connected via the frame so as to be electromagnetically conductive.

9. Device as claimed in claim 1, wherein a first magnet arrangement on one side of the conveyor run is connected to a stationary frame part and at least a second magnet arrangement on the other side of the conveyor run is connected to a frame part which is adjustable between an initial position in contact with the stationary frame part and an operating position raised from the stationary frame part.

10. Device as claimed in claim 9, wherein the adjustable frame part is connected to a lifting mechanism.

11. Device as claimed in claim 7, wherein the adjusting mechanism has a bearing plate which can be adjusted with respect to the stationary frame part, on which the lifting mechanism, the adjustable frame part and the second magnet arrangement connected to it are disposed.

12. Device as claimed in claim 7, wherein the adjusting mechanism has a linear drive.

13. Device as claimed in claim 1, wherein it additionally has a separating mechanism in the region of the conveyor run for mutually separating parts that have become adhered or hooked on one another, with at least one lever projecting into a receiving region and mounted on a pivot axis extending horizontally and at a right angle to the conveying direction.

14. Method of picking up ferromagnetic parts from a quantity of parts by means of a magnetic gripper, incorporating at least one electro-magnet for creating a retaining force and with a sensor system connected to a programmable control unit, wherein a contact element of the sensor system is moved towards the parts and pushed against them, the contact element is moved from an initial position at a relative distance from the electro-magnets into an end position at a distance relatively close to the electromagnet, at least one part is placed against a pick-up surface formed by the contact element and facing away from the electro-magnet by means of the retaining force, and the initial position and/or the end position of the contact element is detected by means of a monitoring element of the sensor system.

15. Method as claimed in claim 14, wherein a positioning element moves the contact element into the initial position fixed by a first stop element and the contact element is held in the initial position by a force.

16. Method as claimed in claim 15, wherein the contact element can be moved out of the initial position into the end position by the retaining force against the action of the force of the positioning element and the end position is fixed by a second stop element.

17. Method as claimed in claim 15, wherein the contact element can be moved out of the initial position into the end position by means of the retaining force in the direction in which the force of the positioning element acts and the end position is fixed by a second stop element.

18. Method as claimed in claim 14, wherein the electro-magnet is not activated until the contact element has reached the end position.

19. Magnetic gripper for picking up at least one ferromagnetic part, incorporating at least one electromagnet for generating a retaining force and a sensor system connected to a programmable control unit, wherein the sensor system has a contact element which can be moved relative to the electro-magnet between an initial position at a relative distance from the latter and an end position relatively close to it, and at least one monitoring element which detects the initial position and/or the end position of the displaceable contact elements, and the at least one part is placed by means of the retaining force against a pick-up surface formed by the contact element and facing away from the electro-magnet.

20. Magnetic gripper as claimed in claim 19, wherein a positioning element is provided which moves the contact element into the initial position and holds it there by means of a force, and the initial position is fixed by means of a first stop element.

21. Magnetic gripper as claimed in claim 20, wherein the contact element can be moved out of the initial position into the end position by means of the retaining force opposite the direction in which the force of the positioning element acts, and the end position is fixed by means of a second stop element.

22. Magnetic gripper as claimed in claim 20, wherein the contact element can be moved out of the initial position into the end position by means of the retaining force opposite the direction in which the force of the positioning element acts, and the end position is fixed by means of a second stop element.

23. Magnetic gripper as claimed in claim 20, wherein the positioning element is provided in the form of a spring, an electric drive or a hydraulic drive.

24. Magnetic gripper as claimed in claim 19, wherein the contact element is made from non-magnetisable material.

25. Manipulating device for manipulating at least one ferromagnetic part with a magnetic gripper, wherein the magnetic gripper is of the type as claimed in claim 19.

26. Conveyor system for conveying and separating parts in batches of differing part lengths, one after the other in the conveying direction, comprising a longitudinal conveyor for conveying the parts in the direction of their longitudinal axis to a transfer position and, adjoining this transfer position, a transverse conveyor for conveying and separating the parts oriented transversely to their longitudinal axis, and guide elements on the transverse conveyor form mutually facing lateral boundary surfaces for at least one conveyor run incorporating a pick-up portion for the parts and a separating region adjoining it, and the parts can be transferred from the transfer position of the longitudinal conveyor into the pick-up portion of the transverse conveyor, wherein the width of the conveyor run between the boundary surfaces can be adjusted by means of an adjusting mechanism depending on the part length, and the transfer position of the longitudinal conveyor can be adjusted between the boundary surfaces of the conveyor run for all parts in batches of differing part lengths.

27. Conveyor system as claimed in claim 26, wherein the front or rear boundary surface of the conveyor run of the transverse conveyor, as viewed in the conveying direction of the longitudinal conveyor, coincides with a stationary reference plane irrespective of the part lengths.

28. Conveyor system as claimed in claim 27, wherein the transverse conveyor has several conveyor runs of differing, fixed width disposed adjacent to one another and the conveyor runs are jointly disposed on a moving carriage which can be displaced by means of the adjusting mechanism in the direction of the longitudinal conveyor, and the guide element respectively forming the front or rear boundary surface of a conveyor run can be displaced into the stationary reference plane for each of the adjacently disposed conveyor runs.

29. Conveyor system as claimed in claim 27, wherein only one conveyor run is provided, in which case the front or rear guide element as viewed in the conveying direction of the longitudinal conveyor forms a stationary first boundary surface coinciding with the stationary reference plane and the guide element forming the oppositely lying second boundary surface can be displaced horizontally and transversely to the conveying direction of the transverse conveyor by means of the adjusting mechanism in order to adapt the transverse conveyor to different part lengths.

30. Conveyor system as claimed in claim 26, wherein the transfer position of the longitudinal conveyor is disposed in a plane lying above the pick-up portion of the transverse conveyor, and a terminal edge of the longitudinal conveyor facing the transverse conveyor and forming the transfer position extends at least as far as the front boundary surface of the conveyor run as viewed in the conveying direction of the longitudinal conveyor, and the terminal edge can be displaced by means of an actuator drive along a guide arrangement and in the conveying direction of the longitudinal conveyor.

31. Conveyor system as claimed in claim 26, wherein a terminal edge of the longitudinal conveyor facing the transverse conveyor extends as far as the rear boundary surface of the conveyor run to be used, as viewed in the conveying direction of the longitudinal conveyor, and at least one transfer mechanism for the parts conveyed on the longitudinal conveyor is provided to the side of the longitudinal conveyor in the region of the transfer position of the longitudinal conveyor.

32. Part-feeding system for conveying and feeding ferromagnetic parts, in particular long parts, incorporating a magnetic gripper for ferromagnetic parts, a transverse conveyor, a conveyor system for conveying and separating parts and a device for conveying and separating ferromagnetic parts, wherein the magnetic gripper is of the type as claimed in claim 19.

33. Part-feeding system for conveying and feeding ferromagnetic parts, in particular long parts, incorporating a magnetic gripper for ferromagnetic parts, a transverse conveyor, a conveyor system for conveying and separating parts and a device for conveying and separating ferromagnetic parts, wherein the conveyor system is of the type as claimed in claim 26.

34. Part-feeding system for conveying and feeding ferromagnetic parts, in particular long parts, incorporating a magnetic gripper for ferromagnetic parts, a transverse conveyor, a conveyor system for conveying and separating parts and a device for conveying and separating ferromagnetic parts, wherein the device for conveying and separating ferromagnetic parts is of the type as claimed in claim 1.
